(19) United States
(12) Patent Application Publication
(10) Pub. No.: US 2025/0176561 A1
(43) Pub. Date: Jun. 5, 2025

(54) STIMULATION OF DORMANCY BREAKING IN A PLANT

(71) Applicants: AGRO INNOVATION INTERNATIONAL, Saint-Malo (FR); INSTITUT NATIONAL DE RECHERCHE POUR L’AGRICULTURE, L’ALIMENTATION ET L’ENVIRONNEMENT (INRAE), Paris (FR); UNIVERSITE DE BORDEAUX, Bordeaux (FR)

(72) Inventors: Noémie VIMONT, Norwich (GB); Bénédicte WENDEN, Bordeaux (FR); Frank A. JAMOIS, La Chapelle-des-Fougeretz (FR); Mustapha Y. ARKOUN, Saint-Jouan des Guérets (FR); Jean-Claude YVIN, Saint-Malo (FR); Florence T. CRUZ, Saint-Malo (FR)

(21) Appl. No.: 18/293,024

(22) PCT Filed: Jul. 27, 2022
(86) PCT No.: PCT/FR2022/051517

§ 371 Date: Jan. 27, 2025

(30) Foreign Application Priority Data
Jul. 27, 2021 (FR) FR2108131

(51) Int. Cl. A01N 65/20; A01N 25/30; A01N 43/16; A01P 21/00

(52) U.S. Cl. CPC A01N 65/20; A01N 25/30; A01N 43/16; A01P 21/00

(57) ABSTRACT

The invention relates to the use of an extract of a leguminous plant of the family Fabaceae in order to stimulate the breaking of dormancy in a perennial fruit plant and a method for stimulating the breaking of dormancy in a perennial fruit plant, in which an extract of a leguminous plant of the family Fabaceae is supplied to said plant in a sufficient quantity to stimulate the breaking of dormancy in said plant.

### TECHNICAL FIELD

The invention finds its application in the agroecological and agricultural field and relates in particular to the stimulation of the dormancy breaking in a plant.

### TECHNOLOGICAL BACKGROUND

The differentiation between seasons represents an important factor for plant life and crop production, particularly in perennial crops.

During cold periods, plants enter a period called “dormancy”. Dormancy is commonly called the “winter break” of the plant. This period prepares the development of latent buds in spring to allow budburst. Dormancy can be divided into two periods: endodormancy and ecodormancy.

Endodormancy corresponds to the inhibition of development originating from the latent bud meristem. It is induced by factors internal to the plant which prevent dormancy breaking, even if external factors are optimal for development. In addition to hormonal regulation, endodormancy is triggered by shortening day length and decreasing air temperature. Winter cooling is necessary to break endodormancy. Cold requirements to break endodormancy vary between plant species and varieties.

When endodormancy is broken, the buds are physiologically ready to bud, but environmental conditions must be favorable at this stage for the endodormancy to break. Plants can persist in a state of ecodormancy if the environmental factors allowing the resumption of root activity and bud development are not optimal. The main environmental factors responsible for the breaking of ecodormancy are temperature (air and soil) and water (soil water content).

However, due to climate change, such as milder winters, the cold requirements associated with this period of dormancy are no longer met, which results in problems with breaking dormancy (delay, incomplete and non-uniform breaking of the buds, heterogeneous budburst, abortion, etc.) leading to poorer flowering and ultimately lower yields.

Thus, in the current context of global warming, the production of fruit trees is threatened and this is true for most fruit species of economic interest.

The seasonal timing of phrenological events is crucial not only for plant survival but also for maintaining high production of fruit trees. According to some models, as global temperatures rise, harvests in some regions are expected to fall by 6 to 10% for every 1° C. increase in temperature. In some regions where cooling temperatures are insufficient, incomplete dormancy breaking has been observed, leading to delayed budburst, low budburst rate and therefore lower yields and poorer quality fruit. The possible solutions are essentially of two types.

First of all, genetics with the creation or selection of new varieties. However, the development of new varieties is a very long process which can last up to thirty years and the effect of climate change is already being felt and has considerably affected certain productions, such as the production of cherries in the South-East of France.

A second solution consists in applying products to the plant that stimulate the breaking of dormancy. The reference product has long been hydrogen cyanamide (product DORMEX®). However, this product is today banned by European regulations due to its toxicity. In addition, the application of the product DORMEX® is restrictive due to its toxicity for bursting buds, which requires application at a very precise date before budburst.

It is therefore important to find short and medium term solutions to maintain the productivity of perennial fruit plant species. It is in this context that the invention is located, which responds to a need for new technical solutions to stimulate the breaking of dormancy in perennial fruit plants.

### SUMMARY OF THE INVENTION

It is in this context that the applicant has demonstrated, and this constitutes the basis of the present invention, that the extracts of a leguminous plant of the family Fabaceae allow to stimulate the breaking of dormancy in a perennial fruit plant.

According to a first aspect, the invention relates to the use of an extract of a leguminous plant of the family Fabaceae in order to stimulate the breaking of dormancy in a perennial fruit plant.

According to a second aspect, the invention relates to a method for stimulating the breaking of dormancy in a perennial fruit plant, in which an extract of a leguminous plant of the family Fabaceae is supplied to said perennial fruit plant in a sufficient quantity to stimulate the breaking of dormancy in said perennial fruit plant.

### DETAILED DESCRIPTION OF THE INVENTION

### Definitions

In the context of the present invention, the term “extract” designates the product resulting from the extraction of compounds contained in a plant. The extraction methods are widely described in the literature and easy to implement by the person skilled in the art. For example, an extract can be obtained by aqueous extraction in an acid, neutral or alkaline medium at different temperatures or else via the use of a solvent. In all cases, the extraction conditions will be determined according to the characteristics of the compounds to be extracted and their location in the different organs of the plant.

The term “leguminous plant” or “fabaceae” refers to a family of dicotyledonous plants of the order of Fabales. It has approximately 765 genera comprising more than 19 500 species. Fabaceae, in the broad sense, are herbaceous plants, shrubs, trees or creepers. In the context of the invention, the leguminous plant of the family Fabaceae may be of the subfamily Faboideae. Preferably, it is a seed leguminous plant of the family Fabaceae, such as soy, bean, pea, chickpea, lentil or broad bean.

In the present description, the terms “extract of a leguminous plant” and “extract of a leguminous plant of the family Fabaceae” are interchangeable.

The term “permeate” refers to the liquid which has passed through the membrane of a chemical separation process (reverse osmosis, ultrafiltration). For example, soy permeate refers to the liquid that has passed through the membrane of a chemical separation process from a soy extract (for example soy fiber extract or soy pulp extract). A soybean permeate can be obtained by ultrafiltration of soybean seed wash water as described in the book Plant Science Review 2011 published by David Henning.

### Use and Method According to the Invention

The present invention arises from the surprising advantages highlighted by the inventors of the effect of an extract of a leguminous plant of the family Fabaceae on the breaking of dormancy in a perennial fruit plant.

The invention indeed relates to the use of an extract of a leguminous plant of the family Fabaceae in order to stimulate the breaking of dormancy in a perennial fruit plant.

The invention also relates to a method for stimulating the breaking of dormancy in a perennial fruit plant, in which an extract of a leguminous plant of the family Fabaceae is supplied to said perennial fruit plant in a sufficient quantity to stimulate the breaking of dormancy in said perennial fruit plant.

Methods for preparing extracts of leguminous plants are widely described in the literature. The extraction method is not limited to a particular method, and the conventionally used methods are applicable for the preparation of the extract of a leguminous plant, for example aqueous extraction in an acid, neutral or alkaline medium.

In one embodiment, the extract of a leguminous plant of the family Fabaceae comprises one or more sugars chosen from raffinose, stachyose and verbascose. The extract of a leguminous plant can thus comprise, by weight in a dry extract, from 0.5% to 10% w/w of raffinose, from 1% to 20% w/w of stachyose, from 0.05% to 5% w/w of verbascose. For example, the extract of a leguminous plant comprises from 1% to 3% w/w of raffinose, from 3% to 11% w/w of stachyose, and from 0.05% to 0.3% w/w of verbascose. For example, the extract of a leguminous plant comprises approximately 3% w/w of raffinose, approximately of 11% w/w stachyose, and approximately 0.1% w/w of verbascose.

In one embodiment, the extract of a leguminous plant of the family Fabaceae is an extract of a seed leguminous plant of the family Fabaceae, such as a soy extract, a bean extract, a pea extract, a chickpea extract, lentil extract and/or broad bean extract. For example, a soy extract may be a soy fibers extract, a soy pulp extract (soy pulp is also called “okara”) or a soy permeate. In a particular embodiment, the extract of a leguminous plant of the family Fabaceae is a soy extract, for example an aqueous soy extract, such as an aqueous soy pulp extract. The aqueous soy pulp extract can, for example, be obtained by mixing soy pulp with water while stirring at a temperature comprised between 20° C. and 25° C. then removing the solid residues, for example by filtration. Example 1 describes a method for preparing an aqueous soy pulp extract.

The extract of a leguminous plant can be more or less concentrated, by adding a solvent (for example water) or by dehydration. Total dehydration of this extract, to obtain a dry extract, allowing presentation in water-soluble pulverulent form can be carried out, for example, by means of a drum dryer or by atomization. The dehydrated extract can be rehydrated to obtain an extract in liquid form that can be applied to the plant.

In one embodiment, the extract of a leguminous plant used in the context of the present invention comprises from 0.001% to 15% of dry extract. Generally, the extract of a leguminous plant comprises 0.1% to 15% of dry extract and can be diluted before use in a solvent, such as water, at a dilution rate ranging from 10 times to 10000 times. For example, an extract of a leguminous plant comprising from 0.5% to 10% of dry extract can be diluted in a solvent in a proportion ranging from 0.01% to 20% v/v.

The composition comprising an extract of a leguminous plant can be prepared by diluting an extract of a leguminous plant in water, and optionally adding a surfactant. Surfactants are widely used in agriculture. The surfactants allow to promote retention on the plant, improve resistance to leaching, optimize spreading, effectively reduce foam, reinforce penetration into the plant, reduce drift and/or improve the compatibility of the mixtures. These may be terpene alcohols, for example terpene alcohols of plant origin, as for the Calanque® surfactant marketed by Action Pin. The surfactant may also comprise alkyl polyether alcohol ethoxylate, alkyl polyglycol and/or aryl polyethoxyethanol, as for the INEX-AR surfactant marketed by Cosmocel and Cosmoagro. The person skilled in the art will have no difficulty in choosing a surfactant suitable for the intended use.

Advantageously, the extract of a leguminous plant is supplied to the plant in liquid form. Preferably, the application of the extract to plants is carried out by air. In a particularly preferred embodiment, the extract of a leguminous plant is delivered to the plant by air in liquid form. Applying the extract by air allows the extract to be directly applied to the buds of the plant.

The extract can be added to the plant when it is desired to stimulate said plant to break dormancy. In particular, the extract is advantageously provided to the plant when the latter has received approximately ¾ of its cold needs. In general, a plant has received ¾ of its cold needs at the end of winter (December/January in the northern hemisphere). Alternatively, the extract can be added to the plant 45 to 55 days before the expected date of budburst.

The skilled person will have no difficulty determining when the plant has received ¾ of its cold requirements. There are different methods for calculating the cold accumulation of the plant to determine when the plant has received ¾ of its cold needs.

The simplest method that is commonly used by producers to know if a plant has received ¾ of its cold needs consists in counting the hours of cold between 0° C. and 7.2° C., knowing that negative temperatures are not counted because they inhibit any development. Cold requirements remain specific to each variety and are generally given as an indication in the variety descriptions. In order to determine ¾ of the cold needs of a plant, the person skilled in the art will therefore be able to rely on data from a nearby weather station and on the cold needs specific to each variety.

Other methods to know if a plant has received ¾ of its cold needs consist in applying more or less sophisticated models, such as the “Utah chill model” which associates temperatures with “chill units”. These models are widely described in the literature.

In a particular embodiment, the extract of a leguminous plant of the family Fabaceae, preferably in the form of a composition as defined above, is supplied to the plant in a quantity ranging from 1 L/ha to 1000 L/ha (liter/hectare), for example from 5 L/ha to 500 L/ha.

The extract of a leguminous plant can be supplied to the plant in a single application or in several applications, for example in two, three, four or five applications. Each application can be more or less spaced out over time. For example, when the extract of a leguminous plant is applied to the plant in two applications, it is preferable to space the two applications from 7 to 15 days apart.

The present invention finds application in the treatment of a very wide variety of plants. Among the latter, mention will particularly be made of perennial plants, for example perennial fruit plants. In particular, the treated plant is a fruit tree, for example a deciduous fruit tree, such as the cherry tree, the plum tree, the peach tree, the apricot tree, the actinide tree, the vine, the apple tree, the pear tree, the lemon tree, the orange tree.

In one embodiment, the extract stimulates the expression of the FLOWERING LOCUS T (FT) gene and/or represses the expression of the DORMANCY ASSOCIATED MADS-box 4 (DAM4) gene. In particular, the extract stimulates the expression of the FT gene at the buds and/or represses the expression of the DAM4 gene at the buds. The applicant has in fact demonstrated that the extract of a leguminous plant of the family Fabaceae activates the expression of the FLOWERING LOCUS T (FT) gene at the buds and/or represses the expression of the DORMANCY ASSOCIATED MADS-box 4 (DAM4) gene at the buds.

The FLOWERING LOCUS T (FT) and DORMANCY ASSOCIATED MADS-box 4 (DAM4) genes are regulatory genes described as being involved in breaking dormancy [1] [2]. The FT gene is a florigen that is highly conserved between plant species, and its expression is often associated with the start of flowering. In perennial species that go through a period of dormancy, the FT gene is activated when dormancy is broken, subsequently leading to budburst and flowering [3]. The DAM4 gene is part of a family of MADS-box-type transcription factors, which are highly expressed during dormancy and repressed upon dormancy breaking [4].

Dormancy and dormancy breaking are also controlled by the reduced-oxidized status of the bud cells [5]. The reduced-oxidized status can in particular be assessed by the ratio between reduced glutathione (GSH) and oxidized glutathione (GSSG). The applicant has also shown that the extract of a leguminous plant increases the GSH (reduced form of Glutathione)/GSSG (oxidized form of Glutathione) ratio at the buds compared to a plant which has not received said extract. Thus, in one embodiment, the extract increases the GSH (reduced form of Glutathione)/GSSG (oxidized form of Glutathione) ratio at the buds of the plant having received the extract compared to a plant that has not received the extract.

In a preferred embodiment, the plant is not further treated with hydrogen cyanamide. This product is currently banned by European regulations due to its toxicity.

Stimulating the dormancy breaking has the effect of improving bud development, homogenizing bud maturity, homogenizing budburst, improving flowering and/or homogenizing the fruits. These improvements are expressed in particular in terms of improved yield and/or quality of the harvest.

The present invention is illustrated by the following non-limiting examples.

### BRIEF DESCRIPTION OF THE FIGURES

FIG. 1: Cherry tree twigs, variety ‘Fertard’, taken from the orchard from trees treated or not with soy extract, and then placed in a forcing chamber (25° C., 16 hours of light) in water to assess the dormancy stage.

FIG. 2: Observations of budburst of cherry trees, variety ‘Fertard’, treated or not with soy extract, 45 and 56 days after treatment.

FIG. 3: Percentage of budburst after transfer to a forcing chamber for cherry tree twigs, variety ‘Earlise’, treated on two different dates.

FIG. 4: Percentage of budburst for cherry tree twigs, variety “Fertard”, cut and treated or not in the laboratory with soy extract, observed after 10 (1 application) and 22 days (2 applications) in growth conditions (25° C., 16 hours of light).

FIG. 5: Percentage of budburst of twigs taken from cherry trees, variety ‘Ferrovia’, treated with soy extract at a concentration of 3%, and compared to twigs treated with the product DORMEX® (AzD) and to water, after three days in growth conditions (25° C., 16 hours of light).

FIG. 6: Percentage of budburst of branches taken from actinide trees treated with two concentrations of soy extract, and compared to twigs treated with the product DORMEX® (AzD) and with water, after three days in growth conditions (25° C., 16 hours of light).

FIG. 7: Ratio calculated between reduced glutathione (GSH) and oxidized glutathione (GSSG) in treated cherry tree buds, variety ‘Fertard’, compared to untreated buds, taken at different dates after treatment.

FIG. 8: Relative expression of the PavDAM4 and PavFT genes in cherry tree buds, variety ‘Fertard’, treated with soy extract compared to untreated buds, taken at different dates after treatment.

FIG. 9: Chromatogram from HPAE-PAD chromatography of the “OKEN” extract. The peaks correspond to: 1-Galactose, 2-Glucose, 3-Fructose, 4-Sucrose, 6-Raffinose, 7-Stachyose, 9-Verbascose. The chromatogram shows that the extract comprises 1.6% raffinose, 5.3% stachyose and 0.25% verbacose.

### EXAMPLES

### Example 1: Material and Method

a. Preparation of “OKEN” Soy Pulp Extract

In a 100 L vessel equipped with a stirring system and a heating system, 95 kg of water were introduced and brought to a temperature of 22° C.+/−2° C. Then, with stirring, 5 kg of okara powder (SOGYFIB product) were introduced into the tank. The medium was maintained at 22° C.+/−2° C. with stirring for 24 h. The mixture was then filtered through a 200 μm pocket filter. The pH of the filtrate thus obtained was then adjusted to 5.5 by the addition of diluted sulfuric acid then supplemented with food preservatives (0.1% to 0.3% w/w) to prevent bacterial proliferation. The extract thus obtained was hereinafter called “OKEN Extract”.

Before its use, the “OKEN” extract was diluted in water at different concentrations and supplemented with surfactant (Example 1b).

b. Products Tested

The following products were tested in the examples:
OKEN extract diluted to different concentrations, supplemented with 0.5% surfactant (“Calanque”, Action Pin, Castets, France or INEX A depending on the examples). The surfactant is systematically added to the diluted “OKEN” extract which is used in the examples, even if it is not mentioned.
Hydrogen cyanamide (Product DORMEX®), as a positive control, at different concentrations, supplemented with 0.5% surfactant (“Calanque”, Action Pin, Castets, France or INEX A depending on the examples). The product DORMEX® has only been tested in the laboratory, as this product is no longer authorized in the fields in Europe. The surfactant is systematically added to DORMEX® in the examples, even if it is not explicitly mentioned.
Distilled water, as a negative control, supplemented with 0.5% surfactant (“Calanque”, Action Pin, Castets, France or INEX A depending on the examples). The surfactant is systematically added to the water in the examples, even if it is not explicitly mentioned.
   c. Characterization of the OKEN Extract

1 ml of the OKEN extract prepared in Example 1a was taken and centrifuged at 12500 RPM for 10 min and the supernatant was filtered through PVDF at 0.2 μm. The filtrate was then diluted then injected into an HPAE-PAD chromatograph (ICS5000+ Thermo Scientific): Thermo Scientific CarboPac PA1 column, Gradient NaOH 200 mM mobile phase, pulsed amperometry detection on gold electrode.

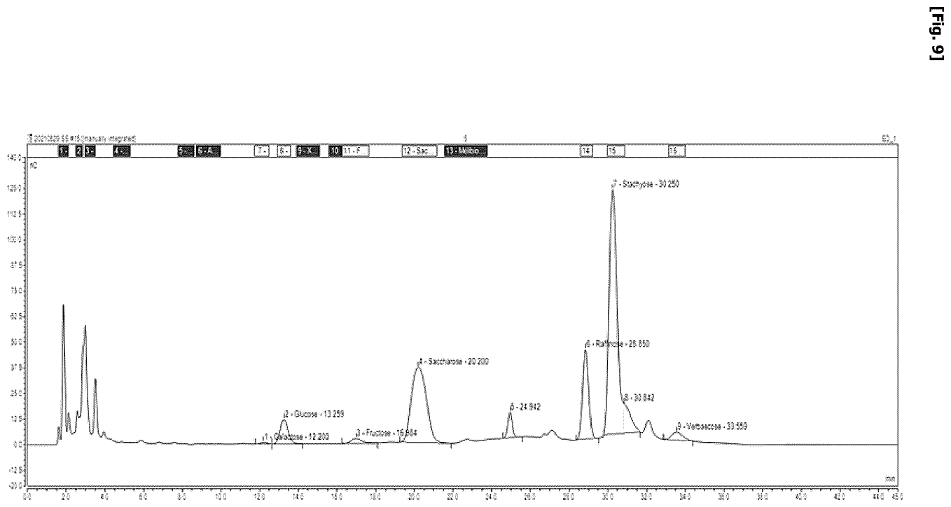

The results are presented in FIG. 9. The chromatogram shows that the extract comprises 1.6% raffinose, 5.3% stacchyose and 0.25% verbascose.

### Example 2: Measurement of the Stimulation of Dormancy Breaking on Cherry and Actinide Trees

### Test 1-Orchard Treatment on Cherry Trees, Varieties ‘Fertard’ and ‘Earlise’

The OKEN extract prepared in Example 1a, diluted in water to a concentration of 0.550% and 1.1% v/v, was sprayed on cherry trees according to the following methods:
1 application at a concentration of 1.1% for the variety ‘Fertard’ on January 12, that is to say when the plant received ¾ of its cold requirements.
2 applications at a concentration of 0.550% one week apart for the variety ‘Earlise’, with a first application on January 12, that is to say when the plant has received ¾ of its cold requirements.
2 applications at a concentration of 0.550% one week apart for the variety ‘Earlise’, with a first application on January 24, that is to say after the date on which the plant received ¾ of its cold requirements.

Water was also sprayed on cherry trees (control).

In this test, the surfactant used was Calanque.

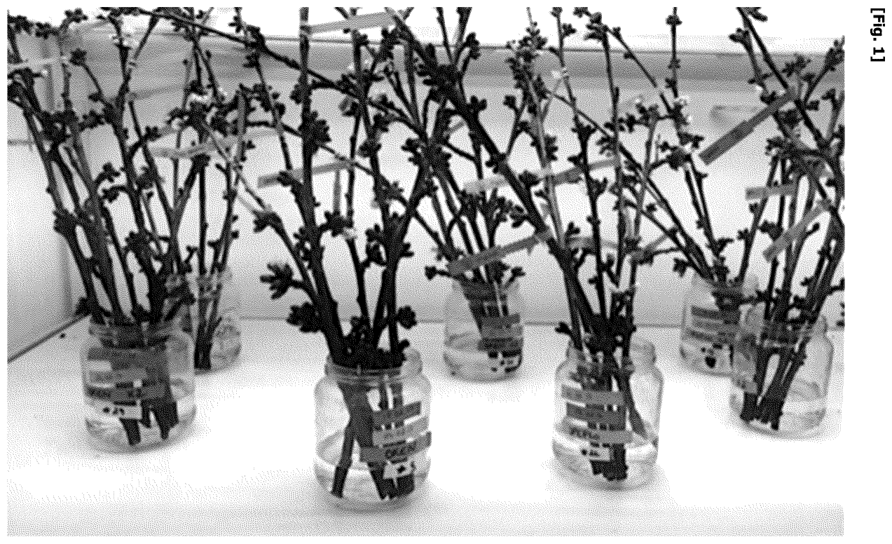

For each variety, branches of treated (OKEN) or untreated (control) cherry trees were collected every week and placed in glass jars filled with water in a growth chamber (25° C., 16 hours of light/day, 60-70% humidity) (FIG. 1). The growth chamber allows to induce the opening of the buds (budburst).

The percentage of budburst (number of budbursting buds relative to the total number of buds) of the collected branches was measured over time following the transfer of the branches to the growth chamber. The budburst percentage reflects the dormancy breaking: the higher the percentage of budburst after transfer to the growth chamber, the more advanced the dormancy breaking is.

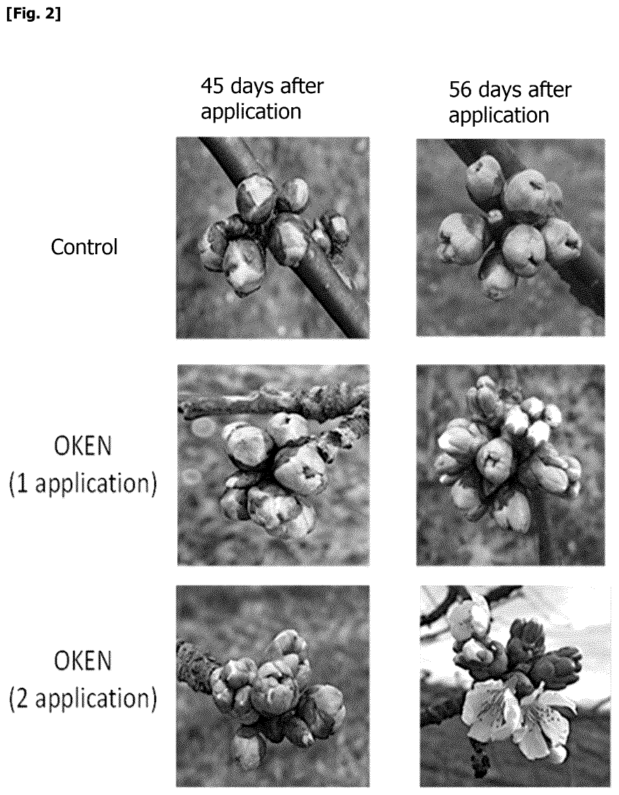

The results for the variety ‘Fertard’ show that the twigs treated with the OKEN extract show earlier budburst (FIG. 2), compared to the untreated twigs.

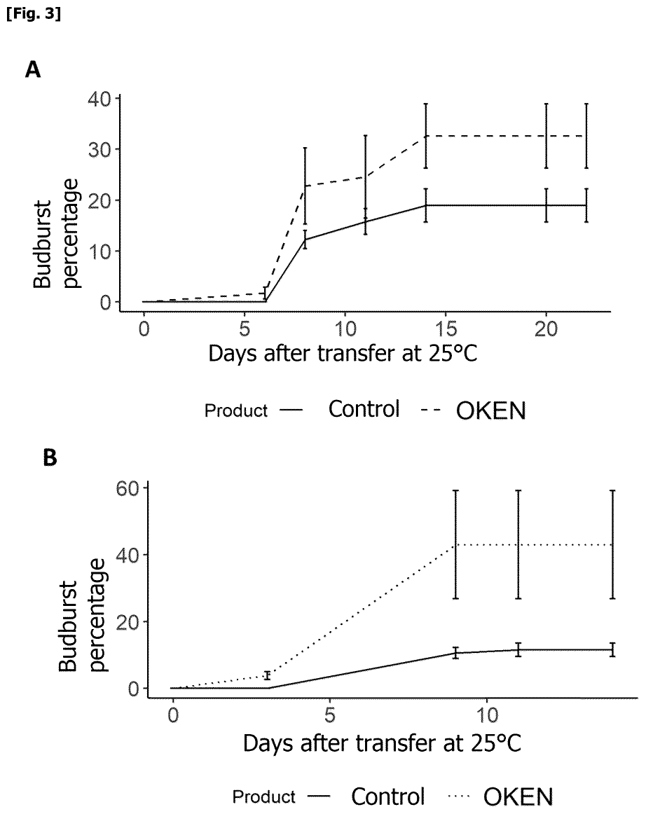

The results for the variety ‘Earlise’ show that the twigs treated with the OKEN extract have a more advanced dormancy breaking (FIG. 3A for the twigs having received a first application on January 12 and FIG. 3B for the twigs having received a first application on January 24), compared to untreated twigs. Soy extract therefore has stimulated the dormancy breaking.

### Test 2-Laboratory Treatment on Cut Twigs of Cherry Tree, Variety ‘Fertard’

Twigs were taken in January, when the plant received ¾ of its cold requirements, on cherry trees of the variety Fertard. The twigs were then treated in the laboratory by vaporization of the OKEN extract prepared in Example 1.a, diluted in water to a concentration of 0.275% or 0.550% (v/v), DORMEX® concentrated at 2%, or water. In this test, the surfactant used was Calanque.

The twigs were treated with a single application of the 0.275% soybean extract or treated with two applications of the 0.550% soybean extract 1 week apart.

The twigs were placed in a growth chamber (25° C., 16 hours of light per day, 60-70% humidity) in glass jars filled with water (FIG. 1) to evaluate the dormancy stage by measuring the budburst percentage.

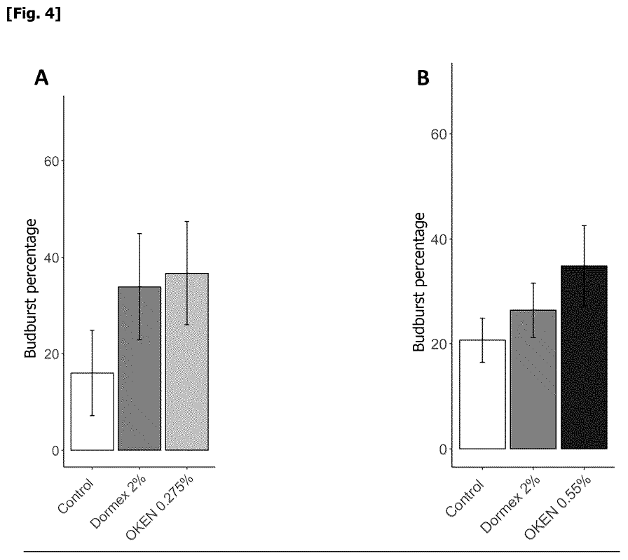

The results are shown in FIG. 4.

The results show that the budburst of the twigs treated with soybean extract is greater than the budburst of the twigs treated with water or DORMEX® 2%, both with 1 single application of soybean extract (FIG. 4A-budburst was observed 10 days after application) and with 2 applications of soy extract (FIG. 4B-budburst was observed 22 days after the first application). This indicates a more advanced dormancy breaking for the buds treated with soy extract. Soy extract therefore has stimulated the dormancy breaking.

### Test 3-Orchard Treatment on Cherry Tree, Variety ‘Ferrovia’

The OKEN extract prepared in Example 1a, diluted in water to a concentration of 3% v/v, was sprayed on cherry trees, variety “Ferrovia”, on two dates in February, in comparison with a single application of DORMEX® diluted in water to a concentration of 3% v/v according to the manufacturer's recommendations, and water for control. In this test, the surfactant used was INEX A.

Twigs were then collected after each treatment and placed in a growth chamber (25° C., 16 hours of light per day, 60-70% humidity) in glass jars filled with water (FIG. 1) in order to study the opening of the buds.

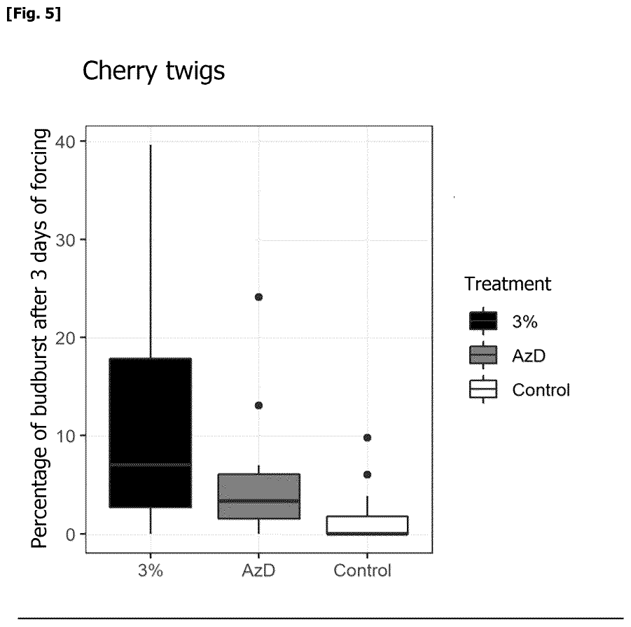

The opening of the buds of the twigs treated with the soy extract was compared to the control twigs and the twigs treated with DORMEX®. The results presented in FIG. 5 show that after 3 days in growth conditions, the twigs treated with soy extract show more advanced budburst than the twigs treated with the other treatments. This indicates a more advanced dormancy breaking for the buds treated with soy extract. Soy extract therefore has stimulated the dormancy breaking.

### Test 4-Orchard Treatment on Actinide Tree, Variety ‘Yellow Latina’

The OKEN extract prepared in Example 1a, diluted in water to a concentration of 0.75% or 3% v/v, was sprayed on actinide trees, variety ‘Yellow Latina’, in comparison with a single application of the product DORMEX® diluted in water at a concentration of 3% v/v according to the manufacturer's recommendations, and water (control). In this test, the surfactant used was Inex A.

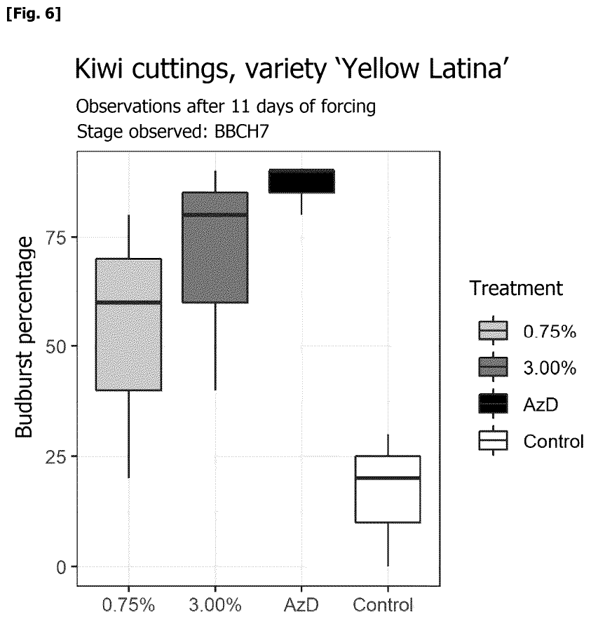

The treated twigs were then collected and transferred to a growth chamber (25° C., 16 hours of light, 60-70% humidity) in glass jars filled with water (FIG. 1) in order to study the opening of the buds. After 11 days, the results presented in FIG. 6 show that the percentage of budburst is greater for buds treated with soy extract or DORMEX® only for the control. This indicates a more advanced dormancy breaking for the buds treated with soy extract and DORMEX®. Soy extract therefore has stimulated the dormancy breaking.

### Example 3: Measurement of Specific Markers of Dormancy Breaking

### Material and Method

### Bud Sampling

Buds of the cherry tree variety ‘Fertard’ were taken directly from trees sprayed with the OKEN extract prepared in Example 1a, diluted in water to a concentration of 0.55% v/v or with water (control) (Table 1).

TABLE 1

| | | | | | | | Date of | Date of |
|---|---|---|---|---|---|---|---|---|
| | | | | Number of | | | treatment | treatment |
| Year | Test | Species | Variety | applications | Treatment | Concentration | 1 | 2 |
| 2017 | Spraying | Cherry | ‘Fertard’ | 2 | OKEN | 0.55% | Jan. 17, 2017 | Jan. 24, 2017 |
| | on tree | tree | | | | | | |
| 2017 | Spraying | Cherry | ‘Fertard’ | 1 | Control | | Jan. 17, 2017 | |
| | on tree | tree | | | (water) | | | |

After sampling, the buds were immediately frozen in liquid nitrogen and were then ground into powder for analysis.

### GSH and GSSG Dosage

### Extraction of Sulfur Metabolites

70 mg of frozen bud powder was weighed into a 2 ml tube and kept in liquid nitrogen before proceeding to the next step. 500 μL of cold milliQ water/methanol 70:30 v/v (stored at −20° C.) containing 0.4% perchloric acid solvent (v/v) was added to the tubes and quickly mixed with a vortex for 10 minutes. Then, the samples were centrifuged (Centrifuge 5427 R, Eppendorf) at 12700 rpm for 15 minutes at 4° C. 400 μL of each supernatant was carefully transferred into new 2 mL tubes without disturbing the pellet. A second extraction was carried out on the remaining powder by adding 500 UL of 0.1% perchloric acid (v/v in milliQ water). Samples were mixed with a vortex for 5 minutes then centrifuged at 12700 rpm for 15 minutes at 4° C. Again, 400 UL of each supernatant was carefully transferred without disturbing the pellet into the tubes containing the previous supernatants. The tubes were inverted several times (or vortexed) to homogenize the liquid. Centrifugation at 12700 rpm for 10 minutes at 4° C. was carried out to pellet suspended particles that may interfere with subsequent steps. The supernatant from each tube was collected in new 2 ml tubes without disturbing the pellet. Finally, the supernatants were diluted 2 times with 0.1% formic acid (v/v in milliQ water) and transferred to 2 mL LC-MS vials.

### Quantification of Sulfur Metabolites by UPLC-QTOF

Ultra-high performance liquid chromatography analysis was performed using a Waters Acquity H-Class UPLC system (Waters Corp, Milford, USA). Separation of metabolites containing sulfur, GSH, GSSG, SAM, OAS, Met, was carried out using a Waters UPLC HSS T3 column (2.1×100 mm, 1.8 m). The mobile phase consisting of water containing 0.1% formic acid (A) and acetonitrile/methanol 50:50 v/v containing 0.1% formic acid (B) was applied with the optimized elution gradient as follows: 100% A at 0-1.5 min, 100-80% A at 1.5-2 min, 80-20% A at 2-2.5 min, 20% A at 2.5-4.5 min, 20-100% A at 4.5-5 min, 100% A at 5-7 min. The flowrate was maintained at 0.4 mL/min and the column temperature was maintained at 25° C.

High-resolution mass spectrometry detection of metabolites was carried out by the Waters Xevo G2-S quadrupole time-of-flight mass spectrometer (QToF MS) (Waters Corp, Milford, USA) equipped with an electrospray ionization (ESI) source. The positive voltage of the ESI source was set at 0.5 kV and the voltage at the cone was 15 V, while the source temperature was maintained at 130° C. with a gas flowrate at the cone of 20 L/h. The desolvation temperature was 500° C. with a desolvation gas flowrate of 800 L/h. Leucine-Enkephalin (Waters, Manchester, UK) was used as a mass reference (ion at m/z 556.2771 in positive mode), which was introduced by a Lockspray at 10 μL/min for calibration of real-time data. MSE data were acquired in centroid mode using a scan range of 50-800 Da, scan time of 0.1 s, resolution of 20000 (FWHM), and a collision energy ramp of 40 to 80 V. The molecular ions [M+H]+ were detected in positive ionization. Chromatographic peaks were extracted from the full scan chromatograms using MassLynx V4.1 software (Waters Inc., USA), based on [M+H]+ ions. Peak areas were integrated using TargetLynx software (Waters Inc., USA).

Expression of PavDAM4 and PavFT Genes by qRT-PCR

Total RNA was extracted from 50-60 mg of frozen bud powder using the RNAeasy Plant mini kit (Qiagen), following the manufacturer's recommendations with some minor modifications (1.5% PVP added to RLT buffer). The genomic DNA was eliminated by DNAse I treatment (TURBO DNA-free kit, AM1907, Invitrogen) then the purified RNA was transcribed using the Transcriptor First-Strand cDNA Synthesis kit (04379012001, Roche), according to the protocol of the manufacturer.

Quantitative PCRs (qRT-PCR) were carried out with the mixture LightCycler 480 DNA SYBR Green I Master mix (04707516001, Roche), with 0.3 UM of primers and 2 μL of cDNA diluted 10 times after synthesis. Fluorescence was quantified by 45 PCR cycles (15 s denaturation at 94° C., 30s g-hybridization at 60° C. and 30s synthesis at 72° C.) on the LightCycler 480 (Roche). The relative expression was analyzed using the delta method from the reference gene UBQ. The primers used are: PavFT (GGACCCGCTTGTTGTT, GTAAACGGGTCTAAAACATCAC) (SEQ ID NO: 1, SEQ ID NO: 2), PavDAM4 (TCAAAGAGGAGAAGAGGGA, TGCCACCTCAGATTCACA) (SEQ ID NO: 3, SEQ ID NO: 4) and PavUBQ (TTGTTCCATACACAGTAGCAT, GTCTGATACCGTCATTGCTTA) (SEQ ID NO: 5, SEQ ID NO: 6).

### Results

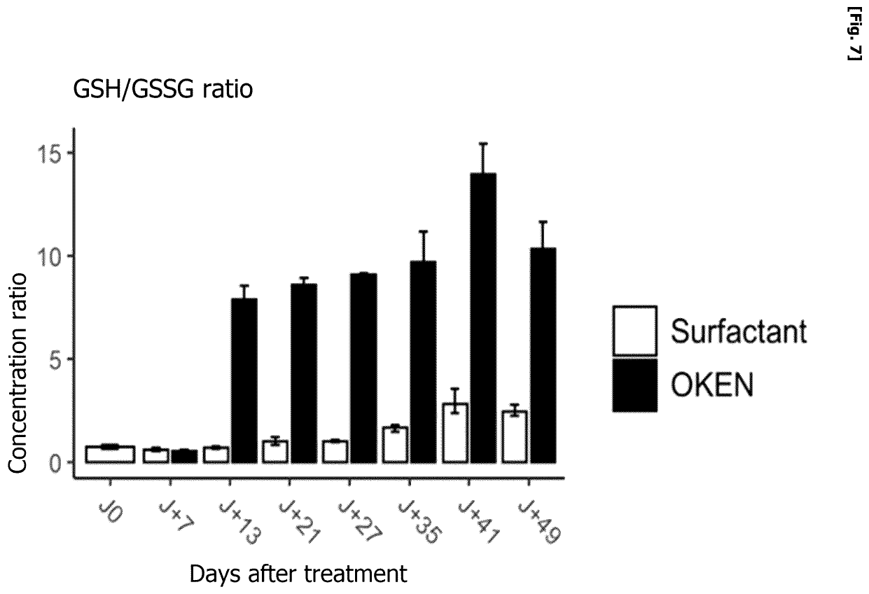

The results on the “GSH/GSSG” ratio are presented in FIG. 7.

The increase in the GSH/GSSG ratio is a marker of breaking dormancy and the results show a much greater ratio in the buds treated with soy extract from 13 days after treatment compared to the untreated control, which shows that the dormancy breaking is stimulated by treatment with soy extract.

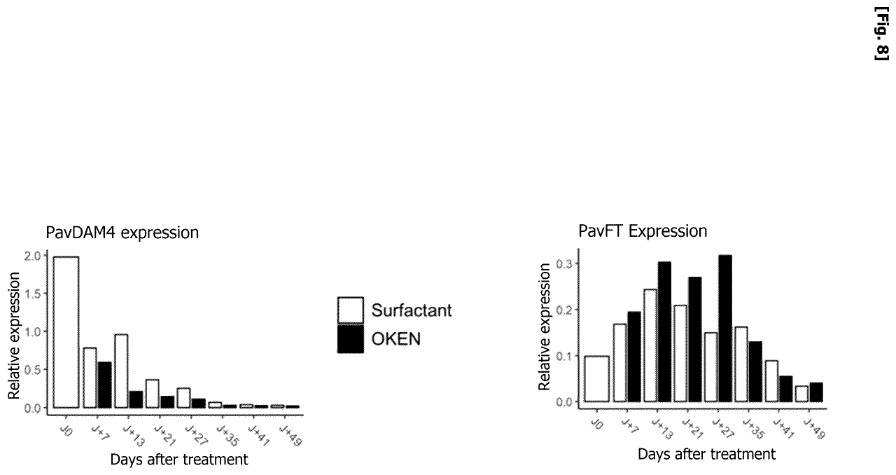

The results on the expression of the PavDAM4 and PavFT genes are presented in FIG. 8.

The results show that PavDAM4 gene is less expressed in buds treated with soy extract compared to the control, suggesting that dormancy breaking is stimulated with soy extract. These results are confirmed by the expression of PavFT, a marker of early dormancy breaking, which is higher in buds treated with soy extract compared to untreated buds.

### REFERENCES CITED

[1] Akiko and al., Physiological differences between bud breaking and flowering after dormancy completion revealed by DAM and FT/TFL1 expression in Japanese pear (Pyrus pyrifolia), Tree Physiology, 2015.
[2] Vimont and al., From bud formation to flowering: transcriptomic state defines the cherry developmental phases of sweet cherry bud dormancy, BMC Genomics, 2019.
[3] Rinne and al., Chilling of Dormant Buds Hyperinduces FLOWERING LOCUS T and Recruits GA-Inducible 1,3-β-Glucanases to Reopen Signal Conduits and Release Dormancy in Populus, The Plant Cell, 2011.
[4] Jimenez and al., Gene expression of DAM5 and DAM6 is suppressed by chilling temperatures and inversely correlated with bud break rate, Plant Molecular Biology, 2010.
[5] Beauvieux and al., Bud Dormancy in Perennial Fruit Tree Species: A Pivotal Role for Oxidative Cues, Front. Plant Sci., 2018.

1. (canceled)

2. A method for stimulating the breaking of dormancy in a perennial fruit plant, in which an extract of a leguminous plant of the family Fabaceae is supplied to said plant in a sufficient quantity to stimulate the breaking of dormancy in said plant.

3. The method according to claim 2, wherein the extract of a leguminous plant of the family Fabaceae is a soy extract.

4. (canceled)

5. The method according to claim 2, wherein the perennial fruit plant is a fruit tree.

6. The method according to claim 2, wherein the perennial fruit plant is:
a deciduous fruit tree selected from the group consisting of a cherry tree, a plum tree, a peach tree, an apricot tree, an apple tree, a pear tree, a lemon tree, and an orange tree; or
a fruit creeper selected from the group consisting of a vine or an actinide tree.

7. The method according to claim 2, wherein the extract comprises one or more sugars chosen from raffinose, stachyose and verbascose.

8. The method according to claim 2, wherein the extract is supplied to the plant in liquid form.

9. The method according to claim 2, wherein the extract is delivered to the plant by air.

10. The method according to claim 2, wherein the extract is supplied to said perennial fruit plant when said perennial fruit plant has received ¾ of its cold requirements.

11. The method according to claim 2, wherein the extract is mixed with a surfactant.

12. The method according to claim 2, wherein the extract stimulates the expression of the FLOWERING LOCUS T (FT) gene and/or represses the expression of the DORMANCY ASSOCIATED MADS-box 4 (DAM4) gene.

13. The method according to claim 2, wherein said extract increases the GSH (reduced form of Glutathione)/GSSG (oxidized form of Glutathione) ratio at the buds of the plant having received the extract compared to a plant that has not received the extract.

14. The method according to claim 2, wherein said perennial fruit plant is not treated with hydrogen cyanamide.

15. The method according to claim 3, wherein the soy extract is an aqueous soy fibers or pulp extract.

16. The method according to claim 5, wherein the perennial fruit plant is a deciduous fruit tree or a fruit creeper.

17. The method according to claim 9, wherein the extract is applied to the buds of the plant.


SEQUENCE LISTING (6 sequences)

SEQ ID NO: 1 - DNA, 16 bp, synthetic construct
  source 1..16: mol_type = other DNA
ggacccgcttgttgtt

SEQ ID NO: 2 - DNA, 22 bp, synthetic construct
  source 1..22: mol_type = other DNA
gtaaacgggtctaaaacatcac

SEQ ID NO: 3 - DNA, 19 bp, synthetic construct
  source 1..19: mol_type = other DNA
tcaaagaggagaagaggga

SEQ ID NO: 4 - DNA, 18 bp, synthetic construct
  source 1..18: mol_type = other DNA
tgccacctcagattcaca

SEQ ID NO: 5 - DNA, 21 bp, synthetic construct
  source 1..21: mol_type = other DNA
ttgttccatacacagtagcat

SEQ ID NO: 6 - DNA, 21 bp, synthetic construct
  source 1..21: mol_type = other DNA
gtctgataccgtcattgctta